(19) United States
(12) Patent Application Publication
(10) Pub. No.: US 2026/0236330 A1
(43) Pub. Date: Aug. 13, 2026

(54) METHOD AND SYSTEM OF GENERATING AN EVENT DRIVEN APPLICATION FOR PERFORMING GOVERNED DATA PROCESSING, COMPILATION, AND ANALYTICS OPERATIONS VIA AN EVENT FRAMEWORK

(71) Applicant: JPMorgan Chase Bank, N.A., New York, NY (US)

(72) Inventor: Ronald CHAN, Tuen Mun (HK)

(73) Assignee: JPMorgan Chase Bank, N.A., New York, NY (US)

(21) Appl. No.: 19/050,644

(22) Filed: Feb. 11, 2025

(51) Int. Cl. G06F 9/54; G06F 8/41

(52) U.S. Cl. CPC G06F 9/542; G06F 8/41

(57) ABSTRACT

A method and system for performing data processing and compilation operations by an event framework is provided. The method includes compiling an application built by an event framework with at least one infrastructure driver having an interface, wherein the at least one infrastructure driver comprises at least one from among a subscriber interface, an event gateway, an event handler, a command gateway, a command handler, an event store, a publishing gateway, a publisher, a projection gateway, and a projector. The method also includes implementing the event framework on a microservice architectural platform by connecting the at least one infrastructure driver with another one of the at least one infrastructure driver, and performing the data processing and compilation operations by executing the event framework.

### FIELD OF THE DISCLOSURE

This technology generally relates to methods and systems of generating an event driven application for performing governed data processing, compilation, and analytics operations via an event framework.

### BACKGROUND INFORMATION

In business operations, there are millions of data spread globally across on various computing environments involving virtual, remote, cloud, and hardware-based computing environments. For regulated business, e.g., financial institutions, there is a need to compile the millions of data and generate meaningful analytical results from these millions of data. For instance, one may need to compile the millions of data spread globally across a widely varying operating and architectural frameworks to generate with meaning analytical result that may be used in support of regulatory actions.

Indeed, in the rapidly evolving landscape of business development, the need to translate new operational functions into automated instructions that generates operational and analytical data operating across the most cost-effective computing environments at the fastest possible pace provides competitive advantages. For highly regulated businesses, e.g., financial institutions, the need to ensure these data can adhere to the evolving landscape of regulations around privacy, data residency, security and traceability as quickly as possible with the evolving business landscape limits the speed at which such businesses are able to quickly respond to the changing demands of regulators and customers.

Traditional software frameworks often suffer from limitations in the ability to ensure the data it generates can be traced across the context of the entire information technology system. In addition, data generated are often not easily portable or segregable, for example, to adhere to new regulation around data residency. Thus, vast amounts of investment must be made in setting up various computing environments as well as changes to the software application before operations can ensure data are operating in and stored in particular locations.

Accordingly, there is a need for techniques to generate an event framework with corresponding application to perform data processing, compilation, and analytics operations.

### SUMMARY

The present disclosure, through one or more of its various aspects, embodiments, and/or specific features or sub-components, provides, inter alia, various systems, servers, devices, methods, media, programs, and platforms for generating an event framework to perform data processing and compilation operations.

According to an aspect of the present disclosure, a method for performing data processing and compilation operations may be provided. The method of performing data processing and compilation operations may be implemented by at least one processor. The method may include compiling an application built by an event framework with at least one infrastructure driver having an interface, wherein the at least one infrastructure driver comprises at least one from among a subscriber interface, an event gateway, an event handler, a command gateway, a command handler, an event store, a publishing gateway, a publisher, a projection gateway, and a projector. The method may also include implementing the event framework on a microservice architectural platform by connecting the at least one infrastructure driver with another one of the at least one infrastructure driver, and performing the data processing and compilation operations by executing the event framework.

The perform the data processing and compilation operations by executing the event framework may include performing a simultaneous check of a data from the subscriber interface by the event gateway to determine whether the data is registered for the data processing and whether the event handler is registered to pre-process an event from the data, and upon determining that the event handler is registered to pre-process the event, performing a call operation to call the event handler. The perform the data processing and compilation operations by executing the event framework may also include performing the pre-processing of the event by the called event handler to generate a resulting data, and transmitting the resulting data to the command gateway and the projection gateway.

The method may also include transmitting the resulting data from the projection gateway to the projector, wherein the projector compares the resulting data with a compiled list of events and annotation codes to partition the resulting data for saving, and executing conditional checks by the projector comprising at least one from among customized checks or checks based on predetermined annotated codes.

The method may also include executing the command handler by the command gateway to process the event to generate the compiled list of events, and transmitting the compiled list of events to the publishing gateway. The method may also include saving the compiled list of events to the event store by the publishing gateway and to an outbox message for publishing by the publisher, and triggering the publisher to load and publish the outbox message.

The data may include at least one from among structured data, raw data, and freeform data.

The method may also include performing a command query responsibility segregation (CQRS) pattern adoption operation by automatically segregating command data processing in the command gateway with data projection via the projection gateway, and implementing a processing pattern architecture to the event framework comprising at least one idempotent event type classification, a singular non-idempotent event type classification, and an at most one non-idempotent event type classification.

According to another embodiment, a computing apparatus for performing data processing and compilation operations may be provided. The computing apparatus may include: a processor; a memory; a display; and a communication interface coupled to each of the processor, the memory, and the display.

The processor may be configured to compile an application built by an event framework with at least one infrastructure driver having an interface, wherein the at least one infrastructure driver comprises at least one from among a subscriber interface, an event gateway, an event handler, a command gateway, a command handler, an event store, a publishing gateway, a publisher, a projection gateway, and a projector. The processor may be further configured to implement the event framework on a microservice architectural platform by connecting the at least one infrastructure driver with another one of the at least one infrastructure driver, and perform the data processing and compilation operations by executing the event framework.

The processor may be configured to perform the data processing and compilation operations that executes the event framework by: performing a simultaneous check of a data from the subscriber interface by the event gateway to determine whether the data is registered for the data processing and whether the event handler is registered to pre-process an event from the data, and upon determining that the event handler is registered to pre-process the event, performing a call operation to call the event handler. The processor may also be configured to perform the data processing and compilation operations that executes the event framework by: performing the pre-processing of the event by the called event handler to generate a resulting data, and transmitting the resulting data to the command gateway and the projection gateway.

The processor may be further configured to: transmit the resulting data from the projection gateway to the projector, wherein the projector compares the resulting data with a compiled list of events and annotation codes to partition the resulting data for saving, and execute conditional checks by the projector comprising at least one from among customized checks or checks based on predetermined annotated codes.

The processor may be further configured to: execute the command handler by the command gateway to process the event to generate the compiled list of events; transmit the compiled list of events to the publishing gateway; save the compiled list of events to the event store by the publishing gateway and to an outbox message for publishing by the publisher; and trigger the publisher to load and publish the outbox message.

The data may include at least one from among structured data, raw data, and freeform data.

The processor may be further configured to: perform a command query responsibility segregation (CQRS) pattern adoption operation by automatically segregating command data processing in the command gateway with data projection via the projection gateway, and implement a processing pattern architecture to the event framework comprising at least one idempotent event type classification, a singular non-idempotent event type classification, and an at most one non-idempotent event type classification.

According to yet another embodiment, a non-transitory computer readable storage medium storing instructions for performing data processing and compilation operations may be provided. The non-transitory computer readable storage medium may include executable code which, when executed by a processor, causes the processor to:

The non-transitory computer readable storage medium storing instructions may further cause the processor to: compile an application built by an event framework with at least one infrastructure driver having an interface, wherein the at least one infrastructure driver comprises at least one from among a subscriber interface, an event gateway, an event handler, a command gateway, a command handler, an event store, a publishing gateway, a publisher, a projection gateway, and a projector; implement the event framework on a microservice architectural platform by connecting the at least one infrastructure driver with another one of the at least one infrastructure driver; and perform the data processing and compilation operations by executing the event framework.

The non-transitory computer readable storage medium storing instructions may further cause the processor to perform the data processing and compilation operations that executes the event framework by: performing a simultaneous check of a data from the subscriber interface by the event gateway to determine whether the data is registered for the data processing and whether the event handler is registered to pre-process an event from the data, and upon determining that the event handler is registered to pre-process the event, performing a call operation to call the event handler. The non-transitory computer readable storage medium storing instructions may also cause the processor to perform the data processing and compilation operations that executes the event framework by: performing the pre-processing of the event by the called event handler to generate a resulting data, and transmitting the resulting data to the command gateway and the projection gateway.

The non-transitory computer readable storage medium storing instructions may further cause the processor to transmit the resulting data from the projection gateway to the projector, wherein the projector compares the resulting data with a compiled list of events and annotation codes to partition the resulting data for saving, and execute conditional checks by the projector comprising at least one from among customized checks or checks based on predetermined annotated codes.

The non-transitory computer readable storage medium storing instructions may further cause the processor to execute the command handler by the command gateway to process the event to generate the compiled list of events, and transmit the compiled list of events to the publishing gateway.

The non-transitory computer readable storage medium storing instructions may further cause the processor to save the compiled list of events to the event store by the publishing gateway and to an outbox message for publishing by the publisher, and trigger the publisher to load and publish the outbox message.

The data may include at least one from among structured data, raw data, and freeform data.

The non-transitory computer readable storage medium storing instructions may further cause the processor to perform a command query responsibility segregation (CQRS) pattern adoption operation by automatically segregating command data processing in the command gateway with data projection via the projection gateway.

The non-transitory computer readable storage medium storing instructions may further cause the processor to implement a processing pattern architecture to the event framework comprising at least one idempotent event type classification, a singular non-idempotent event type classification, and an at most one non-idempotent event type classification.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a system diagram of a computer system.

FIG. 2 illustrates a network diagram of a network environment.

FIG. 3 illustrates a diagram of a system environment according to an embodiment for generating an event driven application for performing governed data processing, compilation, and analytics operations via an event framework.

FIG. 4 illustrates a flowchart of a process for generating an event driven application for performing governed data processing, compilation, and analytics operations via an event framework according to an embodiment.

FIG. 5 illustrates an example development cycles for operational processes associated with generating an event driven application for performing governed data processing, compilation, and analytics operations via an event framework according to an embodiment.

FIG. 6 illustrates an example overview framework architecture of generating an event driven application for performing governed data processing, compilation, and analytics operations via an event framework according to an embodiment.

FIG. 7 illustrates example standardized event framework architecture of generating an event driven application for performing governed data processing, compilation, and analytics operations via an event framework according to an embodiment.

FIG. 8 illustrates example process flow of generating an event driven application for performing governed data processing, compilation, and analytics operations via an event framework with logical data partitioning and data processing according to an embodiment.

FIG. 9 illustrates example interfaces of generating an event driven application for performing governed data processing, compilation, and analytics operations via an event framework with logical data partitioning and data processing according to an embodiment.

### DETAILED DESCRIPTION

In business operations, there are millions of data spread globally across on various computing environments involving virtual, remote, cloud, and hardware-based computing environments. For regulated business, e.g., financial institutions, there is a need to compile the millions of data and generate meaningful analytical results from these millions of data. For instance, one may need to compile the millions of data spread globally across a widely varying operating and architectural frameworks to generate with meaning analytical result that may be used in support of regulatory actions. As such, an integrated framework is needed.

Indeed, in the rapidly evolving landscape of business development, the need to translate new operational functions into automated instructions that generates operational and analytical data operating across the most cost-effective computing environments at the fastest possible pace provides competitive advantages. For highly regulated businesses, e.g., financial institutions, the need to ensure these data can adhere to the evolving landscape of regulations around privacy, data residency, security and traceability as quickly as possible with the evolving business landscape limits the speed at which such businesses are able to quickly respond to the changing demands of regulators and customers.

Traditional software frameworks often suffer from limitations in the ability to ensure the data it generates can be traced across the context of the entire information technology system. In addition, data generated are often not easily portable or segregable, for example, to adhere to new regulation around data residency. Thus, vast amounts of investment must be made in setting up various computing environments as well as changes to the software application before operations can ensure data are operating in and stored in particular locations.

The present application addresses these limitations in the status quo by presenting an innovative event-driven application framework designed to address these challenges by converting business and data intents into instructions that facilitate seamless portability and segregation of data between different cloud and on-premises environments. Additionally, the present application enables data lineage to be traced to its origin without human intervention. Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

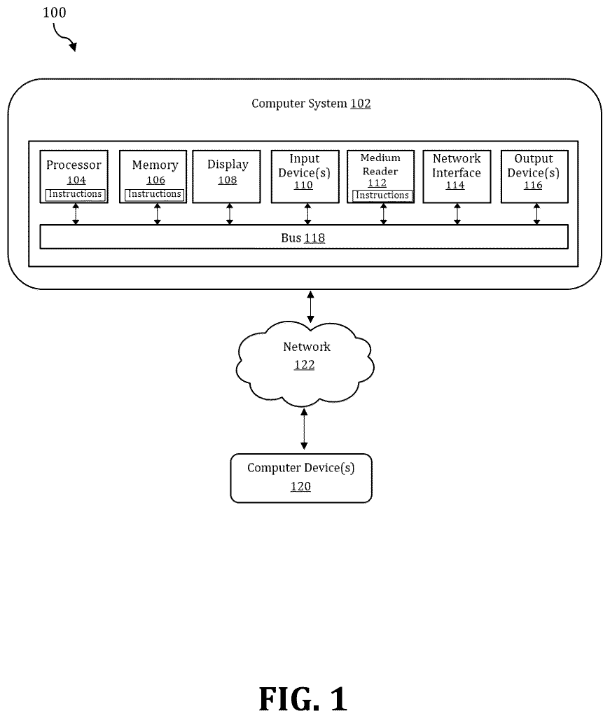

FIG. 1 illustrates a system 100 diagram of a computer system 102 for use in accordance with the embodiments described herein. The system 100 may be generally shown and may include a computer system 102, which may be generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 may be illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 may be an article of manufacture and/or a machine component. The processor 104 may be configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that may store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, digital optical disk, or any other form of storage medium known in the art. Memories may be volatile or non-volatile, secure and/or encrypted, unsecure and/or unencrypted. Of course, the computer memory 106 may include any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed input devices 110 are not meant to be exhaustive and that the computer system 102 may include any additional, or alternative, input devices 110.

The computer system 102 may also include a medium reader 112 which may be configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but not limited to, a local area network, a wide area network, the Internet, a telephony network, a short-range network, or any other network commonly known and understood in the art. The short-range network may include, for example, short-range wireless technology standard used for exchanging data between fixed devices and mobile devices over short distances, low-power wireless ad-hoc mesh networks for linking together, infrared, near field communication, ultra-wideband, or any combination thereof. Those skilled in the art appreciate that additional networks 122 which are known and understood may additionally or alternatively be used and that the networks 122 are not limiting or exhaustive. Also, while the network 122 may be illustrated in FIG. 1 as a wireless network, those skilled in the art appreciate that the network 122 may also be a wired network.

The additional computer device 120 may be illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that may be capable of executing a set of instructions, sequential or otherwise, that specify actions to be taken by that device. Of course, those skilled in the art appreciate that the above-listed devices are merely examples of devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be examples and are not intended to be exhaustive and/or inclusive. Furthermore, the examples of the components listed above are also similarly not meant to be exhaustive and/or inclusive.

In accordance with various embodiments of the present disclosure, the methods described herein may be implemented using a hardware computer system that executes software programs. Further, in a non-limiting embodiment, implementations may include distributed processing, component/object distributed processing, and parallel processing. Virtual computer system processing may be constructed to implement one or more of the methods or functionalities as described herein, and a processor described herein may be used to support a virtual processing environment.

As described herein, various embodiments provide optimized methods and systems of generating an event driven application for performing governed data processing, compilation, and analytics operations via an event framework.

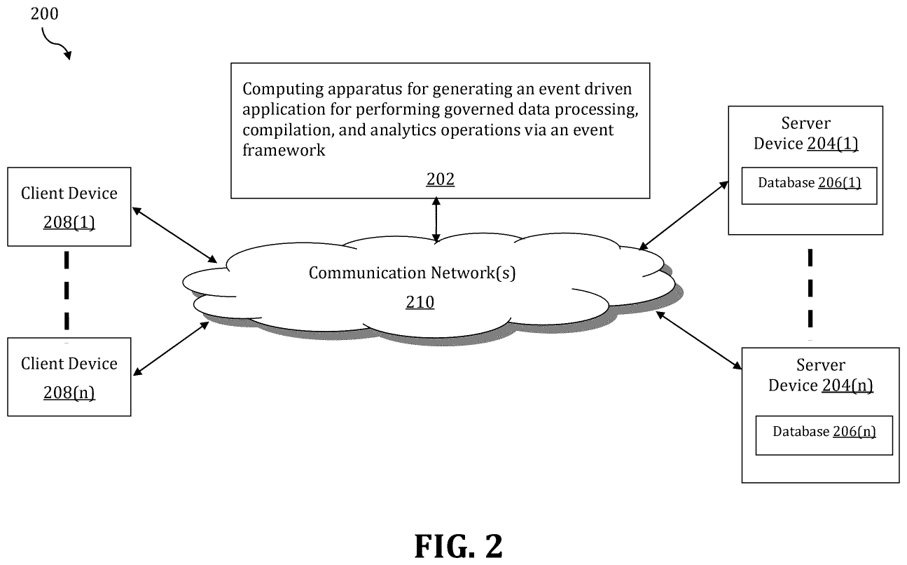

Referring to FIG. 2, a network diagram of a network environment 200 for generating an event framework for performing data processing and compilation operations may be illustrated. In an embodiment, the method may be executable on any networked computer platform, such as, for example, a personal computer (PC).

The method of generating an event driven application for performing governed data processing, compilation, and analytics operations via an event framework may be implemented by a computing apparatus 202 that implements the training of generating an event framework for performing data analytics. The computing apparatus 202 may be the same or similar to the computer system 102 as described with respect to FIG. 1. The computing apparatus 202 may store one or more applications that may include executable instructions that, when executed by the computing apparatus 202, cause the computing apparatus 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s) may be located in virtual server(s) running in a cloud-based computing environment rather than being tied to one or more specific physical network computing devices. Also, the application(s) may be running in one or more virtual machines (VMs) executing on the computing apparatus 202. Additionally, in one or more embodiments of this technology, virtual machine(s) running on the computing apparatus 202 may be managed or supervised by a hypervisor.

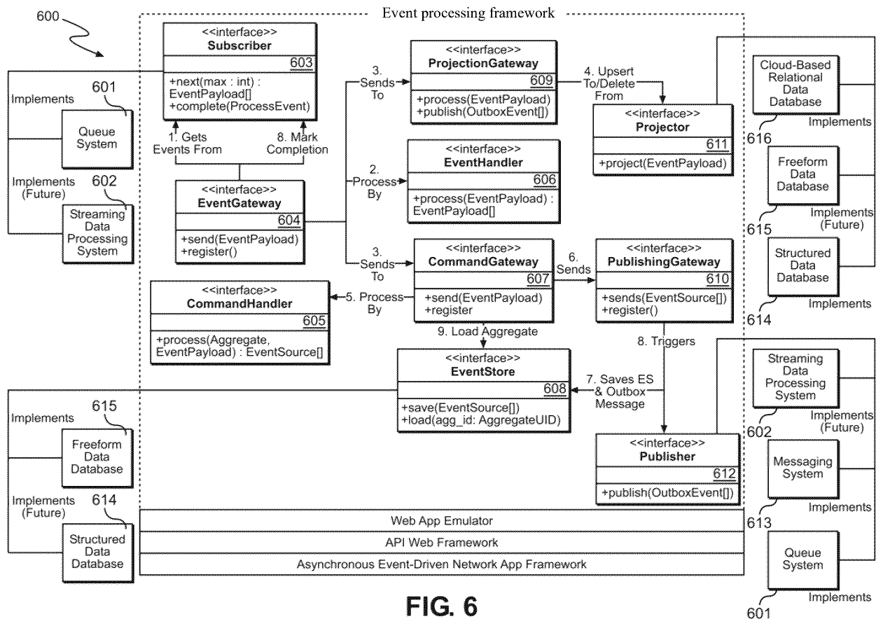

In the network environment 200 of FIG. 2, the computing apparatus 202 may be coupled to a plurality of server devices 204(1)-204(n) that hosts a plurality of databases 206(1)-206(n), and also to a plurality of client devices 208(1)-208(n) via communication network(s) 210. The databases 206(1)-206(n) may be further expanded upon in FIG. 6. A communication interface of the computing apparatus 202, such as the network interface 114 of the computer system 102 of FIG. 1, operatively couples and communicates between the computing apparatus 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used. The server devices 204(1)-204(n) and/or the client devices 208(1)-208(n) may provide different computing environments. See also FIG. 6, which further expands upon the network environment as being described in FIG. 2.

The communication network(s) 210 may be the same or similar to the network 122 as described with respect to FIG. 1, although the computing apparatus 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and computing apparatus that efficiently implement a method of generating an event framework for performing data analytics.

By way of example only, the communication network(s) 210 may include local area network(s) (LAN(s)) or wide area network(s) (WAN(s)), and may use TCP/IP over Ethernet and industry-standard protocols, although other types and/or numbers of protocols and/or communication networks may be used. The communication network(s) 210 in this example may employ any suitable interface mechanisms and network communication technologies including, for example, tele-traffic in any suitable form (e.g., voice, modem, and the like), Public Switched Telephone Network (PSTNs), Ethernet-based Packet Data Networks (PDNs), combinations thereof, and the like.

The computing apparatus 202 may be a standalone device or integrated with one or more other devices or apparatuses, such as one or more of the server devices 204(1)-204(n), for example. In one particular example, the computing apparatus 202 may include or be hosted by one of the server devices 204(1)-204(n), and other arrangements are also possible. Moreover, one or more of the devices of the computing apparatus 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the computing apparatus 202 via the communication network(s) 210 according to the HTTP-based and/or script object notation protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store information.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that may interact with the computing apparatus 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an embodiment, at least one client device 208 may be a wireless mobile communication device, i.e., a smart phone.

The client devices 208(1)-208(n) may run interface applications, such as standard web browsers or standalone client applications, which may provide an interface to communicate with the computing apparatus 202 via the communication network(s) 210 in order to communicate user requests and information. The client devices 208(1)-208(n) may further include, among other features, a display device, such as a display screen or touchscreen, and/or an input device, such as a keyboard, for example.

Although the network environment 200 with the computing apparatus 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems described herein are for example purposes, as many variations of the specific hardware and software used to implement the examples are possible, as will be appreciated by those skilled in the relevant art(s).

One or more of the devices depicted in the network environment 200, such as the computing apparatus 202, the server devices 204(1)-204(n), or the client devices 208(1)-208(n), for example, may be configured to operate as a virtual instance on the same physical machine. In other words, one or more of the computing apparatus 202, the server devices 204(1)-204(n), or the client devices 208(1)-208(n) may operate on the same physical device rather than as separate devices communicating through communication network(s) 210. Additionally, there may be more or fewer computing apparatus 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only tele-traffic in any suitable form (e.g., voice and modem), wireless traffic networks, cellular traffic networks, Packet Data Networks (PDNs), the Internet, intranets, and combinations thereof.

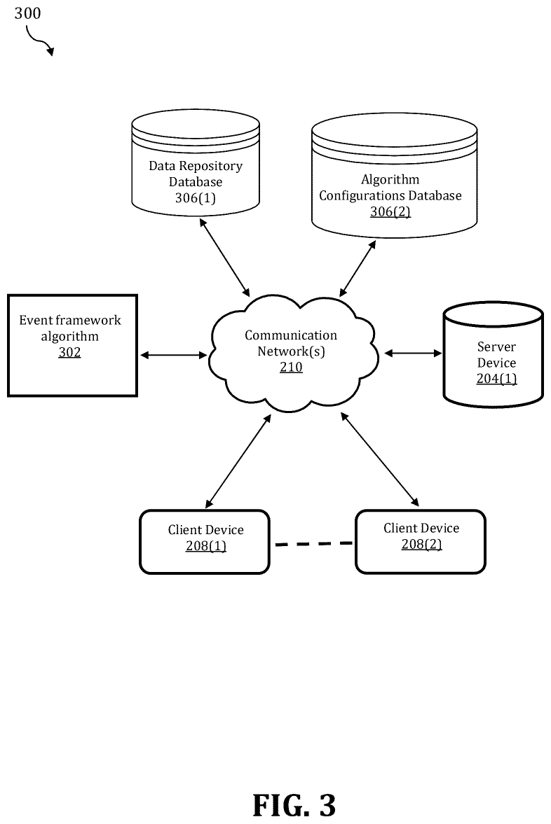

The computing apparatus 202 may be described and illustrated in FIG. 3 as including an event framework algorithm 302, although it may include other rules, algorithms, policies, modules, databases, or applications, for example. As will be described below, the event framework algorithm 302 may be configured to implement a method of generating an event driven application for performing governed data processing, compilation, and analytics operations via an event framework.

FIG. 3 illustrates a diagram of a system environment 300 for implementing a method of generating an event driven application for performing governed data processing, compilation, and analytics operations of FIG. 2, which may be illustrated as being executed in FIG. 3. Specifically, a first client device 208(1) and a second client device 208(2) are illustrated as being in communication with computing apparatus 202. In this regard, the first client device 208(1) and the second client device 208(2) may be “clients” of the computing apparatus 202 and are described herein as such. Nevertheless, it is to be known and understood that the first client device 208(1) and/or the second client device 208(2) need not necessarily be “clients” of the computing apparatus 202, or any entity described in association therewith herein. Any additional or alternative relationship may exist between either or both of the first client device 208(1) and the second client device 208(2) and the computing apparatus 202, or no relationship may exist.

Further, computing apparatus 202 may be illustrated as being able to access a data repository database 306(1) and an algorithm configurations database 306(2). The event framework algorithm 302 may be configured to access these databases for implementing the generating an event driven application for performing governed data processing, compilation, and analytics operations via an event framework.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an embodiment, either or both of the first client device 208(1) and the second client device 208(2) may communicate with the computing apparatus 202 via broadband or cellular communication. Of course, these embodiments are merely examples and are not limiting or exhaustive.

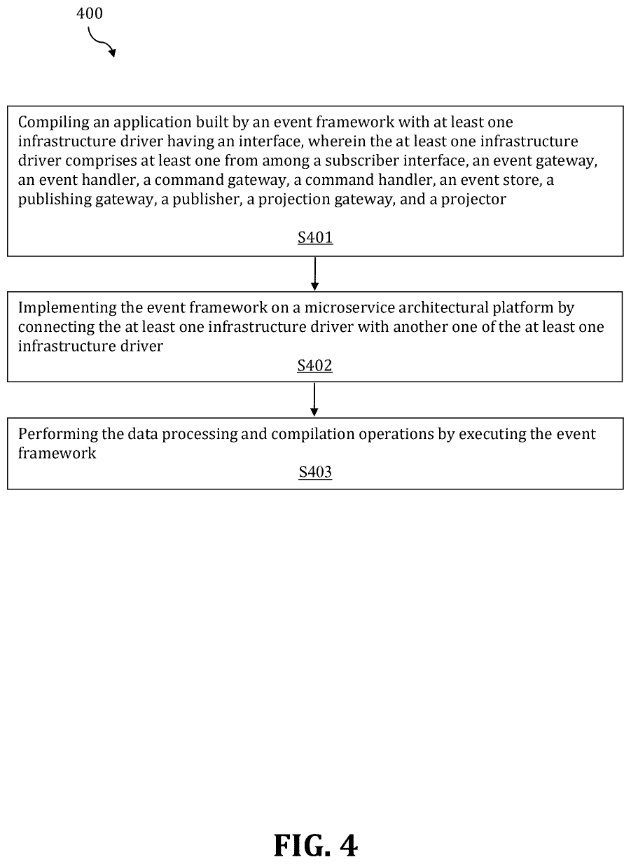

Upon being started, the event framework algorithm 302 may execute a process implementing a method of generating an event driven application for performing governed data processing, compilation, and analytics operations via an event framework. A process for generating an event driven application for performing governed data processing, compilation, and analytics operations via an event framework may be generally indicated at flowchart 400 in FIG. 4.

FIG. 4 illustrates a flowchart of a process diagram 400 of a process for generating an event driven application for performing governed data processing, compilation, and analytics operations via an event framework according to an embodiment. At step S401 of the flowchart process 400, the computing apparatus 202 may compile an application built by an event framework with at least one infrastructure driver having an interface. The at least one infrastructure driver may include at least one from among a subscriber interface, an event gateway, an event handler, a command gateway, a command handler, an event store, a publishing gateway, a publisher, a projection gateway, and a projector.

At step S402, the computing apparatus 202 may implement the event framework on a microservice architectural platform by connecting the at least one infrastructure driver with another one of the at least one infrastructure driver.

At step S403, the computing apparatus 202 may perform the governed data processing, compilation, and analytics operations by executing the event framework. The performing the governed data processing, compilation, and analytics operations by executing the event framework may include performing a simultaneous check of a data from the subscriber interface by the event gateway to determine whether the data is registered for the data processing and whether the event handler is registered to pre-process an event from the data, and upon determining that the event handler is registered to pre-process the event, performing a call operation to call the event handler. The performing of the data processing and compilation operations by executing the event framework may also include performing the pre-processing of the event by the called event handler to generate a resulting data, and transmitting the resulting data to the command gateway and the projection gateway. The data may include at least one from among structured data, raw data, and freeform data. The data may originate from at least one database such as a messaging system database, a streaming data processing system database, a queue system database, a non-relational key-value database, a relational database, and/or a cloud-based relational database.

An event handler may be capable of handling an incoming event. Event handler may by identified by the event signature alongside an @EventHandler annotation and can be located in any code component, package, or classes in the event driven application. Event handlers may receive two parameters: (1) an event metadata and (2) an event data object. When an event is received, an event framework search for the corresponding event handler may be invoked based on an annotation and a function's event signature as described above. An event data claim name may be any name, but only one unique event handler per data class may be permitted. If no event handler is found, then the event framework Would not execute any pre-processing of the event, and instead, pass the event downstream to both the command and projection gateway simultaneously to see if the event is registered for processing in either command or projection gateways in a command query responsibility segregation (CQRS) pattern. Additionally, events can also be annotated as commands.

The performing of the governed data processing, compilation, and analytics operations by executing the event driven application via the event framework may further include transmitting the resulting data from the projection gateway to the projector, wherein the projector compares the resulting data with a compiled list of events and annotation codes to partition the resulting data for saving, and executing conditional checks and/or transformation of data by the projector comprising at least one from among customized checks or checks based on predetermined annotated codes.

Examples of predetermined annotated codes may include framework annotations such as, but not limited to: @Aggregate, @AggregateID, @Aggregate Version, @Event, @Command, @EventSource, @EventHandler, @CommandHandler, or @EventSourceHandler. The @CommandHandler annotation may tell the event framework that the Aggregate class in which the function is located may be capable of handling the corresponding command. The @CommandHandler annotated function may represent a location for placing business logic for governed data processing.

The @EventSourceHandler may tell the event framework that the annotated function should be called when the Aggregate is sourced from its events. Event store may collect the whole history of event sources for each aggregate ID. To obtain the current state of an aggregate, all events are loaded and applied in sequence (sorted by event source version). This apply method may be event source handlers. As all the Event Sourcing Handlers combined can form the Aggregate, this is may be where the state changes happen.

Other fields may also store data of the aggregate to collectively generate the state of an aggregate. Aggregates may be combined or one aggregate alone can form a microservice with its own business logic, wherein each of the aggregates can communicate with other aggregates asynchronously via sending events or commands to their respective subscriber driver.

The performing of the data processing and compilation operations by executing the event framework may further include executing the command handler by the command gateway to process the event to generate the compiled list of events, and transmitting the compiled list of events to the publishing gateway. The performing of the data processing and compilation operations by executing the event framework may also include saving the compiled list of events to the event store by the publishing gateway and to an outbox message for publishing by the publisher, and triggering the publisher to load and publish the outbox message.

An event store may store computational results of events as event sources. Since events may generally not to be modified because an event is a fact that something happened and facts should not be modified, an event store should be optimized for appending data. Additionally, event ordering may play an important role in event-sourced systems (e.g., the event framework) because despite the countless times that the materialized state may be reconstructed, the end result should still be the same.

In an example, a command Tt may be needed to define the command handlers directly for an aggregate that contains a state to process this command. To define a command handler in an aggregate, a simple annotation may be performed which should handle the command with @CommandHandler. The @CommandHandler annotated technique may become a command handler for a command message class where the command fully matches a qualified class name of a second parameter of that technique. The first parameter should generally be the event. Thus, a signature of a void handle (which may be denoted as iEvent event, CreateOrder command) may be annotated with @CommandHandler, which may enable the command handler of the CreateOrder command messages. The signature name of such a void handle technique can be any such technique name and does not require the term “handle” within the technique name.

Within an aggregate, there may be an indication of a specific location to perform business logic validation and aggregate state changes. The command handlers may decide whether an aggregate is in the correct state. If yes, then an event is published. If not, then the command might be ignored or an exception can be given, depending on the needs of the domain.

Event source handlers may be applied to generate the current state of an aggregate. For example, an order with aggregateUID=“order1” and version=1 may be created with event “OrderCreated”. Then, an order may be confirmed with “OrderConfirmed” event. So, the event store would contain records of both events in order. A UID may denote a unique identifier. Additionally, the microservice would receive a ConfirmOrder command. To process this command, the event framework would first load all event sources of this aggregate and execute the corresponding event sources handlers. That is, the event framework would: (1) load the OrderCreated event source and call the OrderCreated event source handler, and (2) load the OrderConfirmed event source and call the OrderConfirmed event source handler.

The method for performing data processing and compilation operations may further include performing a command query responsibility segregation (CQRS) pattern adoption operation by automatically segregating command data processing in the command gateway with data projection via the projection gateway, and implementing a processing pattern architecture to the event framework may include at least one idempotent event type classification, a singular non-idempotent event type classification, and an at most one non-idempotent event type classification.

The processing pattern architecture to the event framework with idempotent and non-idempotent event type classifications associated with the data and processed may be described as shown in Table 1. As shown in Table 1, there may be two types of command handling: idempotent and non-idempotent. An idempotent event does not change the state of the aggregate if applied more than once. For example, there is no difference if an “account deleted” event is applied once, twice, or more times. The outcome would be the same, i.e., the account would be deleted. A non-idempotent event such as a “payment” event would impact the aggregate state if applied more than once. Thus, edge case scenarios can be handled when the same event can be received many times.

TABLE 1
Processing patterns for common event class types.

| Event type | Re-processing risk | Processing needs |
|---|---|---|
| Idempotent | Risk free | At least once, retriable |
| Non-idempotent | Low/no risk | Exactly once, retriable |
| Non-idempotent | High risk | At most once, non-retriable |

By default, command events may be assumed to be non-idempotent. Through annotations, users may define characteristics of the events. Standardization of common event messaging and tracking of the cause related to event unique ID may allow framework level post-processing/pre-persistent guarantees using atomicity of event stores.

In an event framework, causes of the event sources (e.g., the original event that caused the generation of an event source) can be saved to facilitate two functions: (1) an event store load via a ByCause function to enable an idempotent command's handlers to obtain previously generated event sources based on a cause event unique identifier. This enables republication of event sources with no reprocessing. The second (2) function may be that for non-idempotent commands, the saved cause may be used to ensure exactly-once processing. Exactly-once processing may refer to a process for ensuring that the processing happens successfully exactly once. However, a process can still be partially processed at least once, because it might not complete processing, so the process retries the processing. In some cases, it may be desired that the processing instead be an at-most-once processing (e.g., with payment/transfer transaction application program interface calls)

Such tracking of the event sources by the event framework is one advantage or benefit of the event framework. For instance, this tracking by the event framework may enable a naturalized audit trail of events for compliance with certain regulations. That is, in order to comply with certain regulations, a software system (e.g., the event framework) may be required to provide a full audit log. An event-sourced system such as the event framework as described in the present applicant can provide such a full audit log.

Yet another advantage or benefit of the event framework may be related to data analytics. For instance, the full history of interactions may be stored in an event store, wherein various machine learning algorithms may be executed on the interactions to extract information from these interactions that matter to the business organizations.

Yet another advantage or benefit of the event framework may be related to design flexibility. An agile approach to building software systems necessitates the ability to adapt to any changes as part of the event stream. For instance, an ability to replay the event stream from an initial time point with new business logic enables validation of events and outcomes of the past event as new designs and logics are implemented.

Yet another advantage or benefit of the event framework may be related to temporal reports. As may be commonly known, it would be difficult to investigate an incident that happens in production because that requires digging through countless log data and countless reasoning about the state that the software system was at for that point in time. As such, event sourcing via an event framework provides a way to replay events to a certain point in time and debug the application in a state in which the incident occurred.

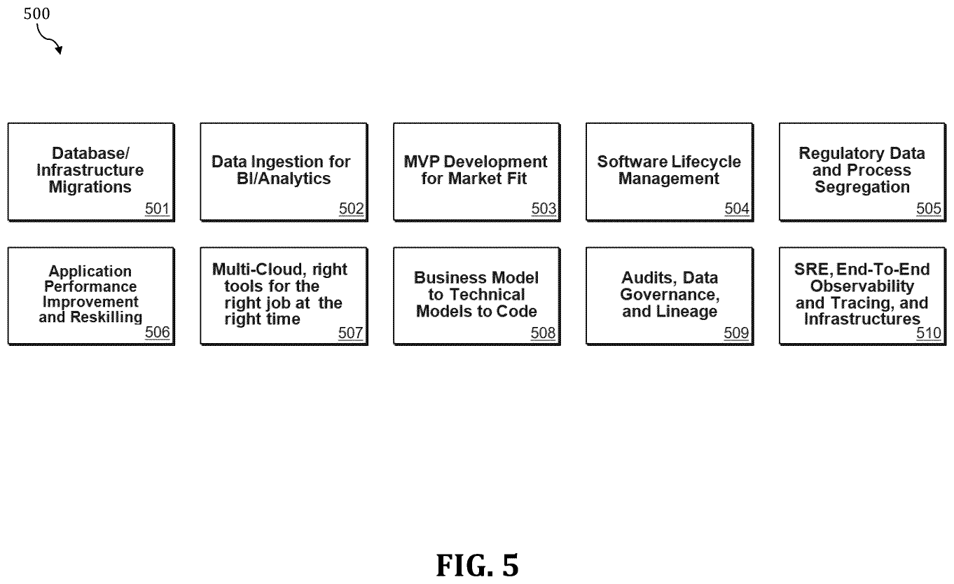

FIG. 5 illustrates an example development cycles for operational processes 500 associated with generating an event framework for performing data processing and compilation operations according to an embodiment as described in FIG. 4. The present application provides techniques for standardizing general-purpose software development capabilities through amalgamating cohesive architectural best practices that improves metrics such as, but not limited, time to market, agility, reliability, security and transparency. Thus, enabling organizational cost advantage at scale, delivered through an engineer-oriented software framework, i.e., the event framework.

The challenges in development cycles for operational processes 500, e.g., business operational processes, may include database/infrastructure migrations 501, data ingestion for business intelligence (BI)/analytics 502, minimum viable product (MVP) development for market fit 503, software lifecycle management 504, regulatory data and process segregation 505. The challenges can be mitigated with application performance improvement and reskilling 506; multi-cloud with the right tools for the right job at the right time 507; converting business model to technical models to code 508; audits, data, governance, and data lineage 509; and site reliability engineering (SRE), end-to-end observability and tracing, and infrastructures 510. The various potential challenges in the developmental cycles of processes 501-505 may be mitigated by the respective actionable processes 506-510, wherein such abstraction with improved processes may result in a minimum of 50% reduction in effort.

FIG. 6 illustrates an example overview framework architecture 600 of generating an event driven application for performing governed data processing, compilation, and analytics operations via an event framework according to an embodiment as described in FIG. 4. The example overview framework architecture 600 may enable an abstraction of common general processing, allowing implementation of infrastructure specific drivers with the event framework. The event framework being implemented with a lowest common denominator of features with the ability to utilize middleware specific advantages wherever it may be advantageous to do so. Indeed, the benefits of the example overview framework architecture 600 of the event framework may include, but is not limited to: multi-cloud enablement, data middleware agility, event sourcing (e.g., audit trail), command query responsibility segregation (CQRS that provides online analytical processing and online transactional processing for optimized data stores), and business logic independence of infrastructure data publishing agility.

The event framework may provide portable processing of events via e.g., specific business process instructions that enables resulting outputs (i.e., event sources) may be persisted and published. Thereupon, transformations of events may be performed to project the event data into analytical databases across various virtual, cloud, and hardware based computing environments.

An event may be a specific data format composed by an external system when an action may be triggered either via a user interface, by the arrival of external data, or by the application framework as the result of processing business process instructions (i.e., event sources). The format of an event may be composed of a timestamp, an event type descriptor, and a universally unique identifier (UUID). The format of an event may also include specific data of interest related to the event type. Various embodiments may compose an event to be supplied to the application framework for processing by specific business process instructions.

For instance, an event may be a data that the event framework receives from other microservices. As an example, a Fulfillment Created Event may be an event recognized by the event framework for the event handler or command handler to be executed.

Continuing with the example overview framework architecture 600, a queue system 601 may be implemented to transmit input data (e.g., queue data) into an input gateway such as a subscriber/user interface 603. The subscriber/user interface 603 performing a next operation to obtain a next event payload and a complete operation related to processing the event. In an event payload, the data field with an object type may be specified. This data object can be either an event, a command, or event source annotated class. The data classes may contain specific information that updates an aggregate state. An event source annotated class may be a data type to describe event to publish and save into an event store. An aggregate may be an entity or group of entities that are kept in a consistent state (e.g. within a single transaction). An aggregate may be a prime building block in any CQRS based applications. As such, an aggregate may be a regular object, which contains a state or methods to alter that state. When creating the aggregate object, one may effectively create aggregate root, typically carrying the name of the entire aggregate.

A streaming data processing system 602 may also be implemented (either presently or a future time as so desired) to transmit input data (e.g., streaming data) into an input gateway such as the subscriber/user interface 603. The subscriber/user interface 603 may also obtain event data from an event gateway 604 as indicated by step 1.

For example, in one aspect, data from incoming infrastructure drivers (e.g., subscribers) may be compiled, whereby commands or events from external processes may be sent into the application framework for processing from various data transmission infrastructure medium operating across various virtual, cloud, or hardware-based computing environments. In a related aspect, events may be published by compiling outgoing infrastructure drivers (e.g., publishers). This may enable the core business process instructions residing in the application to be agnostic of the infrastructure and medium of the incoming and outgoing data channels, since drivers may be implemented for new infrastructure channels and configured and provided to application software package on start-up execution without affecting other parts of the application.

Continuing with the example overview framework architecture 600, the event gateway 604 may also send the event data to a projection gateway 609 (step 3), as well as send the event data to the event handler 606 for processing by the event handler 606 (step 2).

The projection gateway 609 may perform an upsert to/deletion from operations (step 4) in correlation with a projector 611. The upsert to operation may include updating and inserting the updated data (e.g., event data) from projection gateway 609 to the projector 611. The projection gateway 609 may operate to analyze incoming events data and supply it to s corresponding projector in order for data to be updated according to an annotated event projection behavior, enabling purposely-built user-defined data analytics databases/data warehouse/data lake to be updated accordingly.

The projector 611 may perform a projection operation with implementation of various databases. For instance, the databases may include, but are not limited to, structured data database 614, freeform data database 615, and cloud-based relational data database 616. The various databases may be presently implemented or at a future time as so desired.

For a projection, the event framework may support a non-relational database that can store data in a non-tabular format (e.g., non-structured query language databases) and relational database service projections. To enable event projection, a projection annotation can be specified together with an event annotation in the event data class. A filter annotation may also be used to filter events for a projection.

The event handler 606 may perform another process operation of processing the event payload to parse for data objects such as commands and then sends such commands to a command gateway 607 (step 3).

The command gateway 607 may be registered with a list of events that it can process through annotation, and after which, when the command gateway is sent an event payload registered, it can process the event. The command gateway 607 may perform an operation to load related aggregate event data (step 9) of the incoming command from an event store 608. The command gateway 607 may transmit the commands of the event data for processing by (step 5) a command handler 605. The command gateway 607 may also send the commands of the event data (step 6) to a publishing gateway 610.

The event store 608 may perform a save operation (e.g., saving a source of the event data) and a load operation (e.g., loading an aggregate unique identifier). The event store 608 may perform a store operation with implementation of various data e.g., various databases. For instance, the databases may include, but are not limited to, structured data database 614, freeform data database 615. The various databases may be presently implemented or at a future time as so desired. The command handler 605 may perform process operation of aggregating the event payload and the event source.

The publishing gateway 610 may perform a send operation and a register operation, resulting in saving the event source and outbox message (step 7). The publishing gateway 610 may also trigger (step 8) a publisher 612 to perform a publish operation publishing an outbox event. The publisher 612 may perform the publishing operation with implementation of various systems/For instance, the systems may include, but are not limited to, messaging system 613, queue system 601, and streaming data processing system 602. The various systems may be presently implemented or at a future time as so desired.

The example overview framework architecture 600, i.e., the event framework, may be implemented on a web app emulator with an application programming interface (API) web framework and an asynchronous event-driven network application framework.

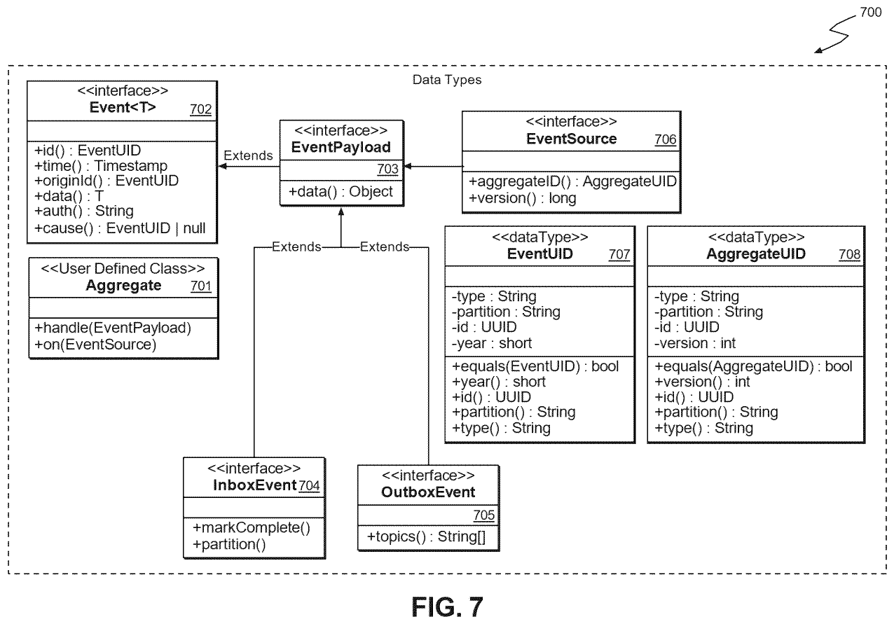

FIG. 7 illustrates example standardized event framework architecture 700 of data types of generating an event driven application for performing governed data processing, compilation, and analytics operations via an event framework according to an embodiment as described in FIG. 4.

In the example standardized event framework architecture 700 of data types, an event source interface 706 may enable an aggregation that may include an aggregation of a unique ID with a version. An aggregate 701 user defined class may be performed on a user defined class. The aggregate 701 may include a handle on the event payload and on the event source. Aggregates may be logical containers of a series of persisted sources of events (i.e., event source).

The event source data may be sent from the event source interface 706 to an event payload interface 703 that may be include data object. The event payload interface 703 may extend to the ID event interface 702, which may perform operations related to obtaining the event unique ID, time stamp of the event, authenticating string, origin ID, cause, etc. The inbox event interface 704 and outbox event interface 705 may also be extended to the event payload interface 703 to provide various data to the event payload interface 703. The example standardized event framework architecture 700 of data types may also include data type event unique ID 707 and data type aggregate unique ID 708 with various strings and related to the event unique ID and aggregate unique ID.

Continuing with FIG. 7, chain reactions of event processing may result in a series of event source events published with specific event unique ID. Every event composed of a global event unique ID may consist of a name of the type of event, the partition of the event, a year and a universal unique ID unique to the 3 parameter acts as the basis for tracing events universally. Aggregates together may compose the current state of an aggregated entity and records the cause e.g., an event identifier for tracing within a microservice. When multiple microservices exchange standardized formats of events, data lineage level distributed tracing may identify root event ex-post. Since end-to-end processing of events happens at the framework level, distributed tracing instrumentation may happen at a common layer. Telemetry tracking and managing platform may be used to instrument the event framework to enable telemetric data collection and distribution in a centralized manner.

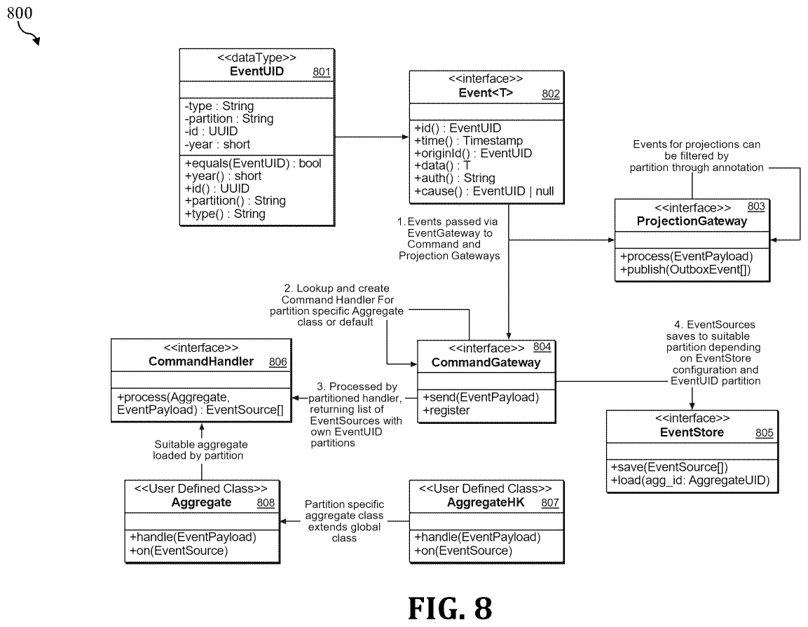

FIG. 8 illustrates example process flow 800 of generating an event driven application for performing governed data processing, compilation, and analytics operations via an event framework with logical data partitioning and data processing according to an embodiment as described in FIG. 4.

A data type event unique ID 801 may provide data to an event interface 802, which may perform operations related to obtaining the event unique ID, time stamp of the event, authenticating string, origin ID, cause, etc. At step 1, events may be passed from the event interface 802 via an event gateway to command gateway 804 and projection gateway 803. The projection gateway 803 may perform processes related to the event payload, e.g., filtering events by partitioning through annotation, and publishing the processed result to outbox event.

To facilitate mapping of event messages to target infrastructure specific data stores, a common language and pattern of projecting events into target stores may be created that may access the standardized event messaging data, and map it to pre-defined target locations. Each type of projector may contain target specific configurations and naming conventions, in addition to a common set of non-infrastructure dependent configuration such as operation and filters that facilitate the ability to define the expected action, and to filter events for projection based on a programming expression language. An example code regarding this process is provided below.

```
/**
  * Fulfilment Created Event
  *
  * @param fulfilment
  * @param orderID
  */
@Event
@Projection(sqlTables = {
    @SqlTable(name = “Fulfilment”, operation = Operation.CREATE, primary =
@SqlColumn(property = “fulfilment.uid”, column = “id”), columns = {
      @SqlColumn(property = “orderID”, column = “orderId”),
      @SqlColumn(property = “fulfilment.version”, column = “version”)}),
    @SqlTable(name = “Fulfilment_HK”, operation = Operation.CREATE, filters = {
      @Filter(property = “fulfilment.uid.partition”, value = “HK”)}, primary =
@SqlColumn(property = “fulfilment.uid”, column = “id”), version = @SqlColumn(property
= “fulfilment. version”, column = “version”), columns = {
      @SqlColumn(property = “orderID”, column = “orderId”)}),
    @SqlTable(name = “Fulfilment_TW”, operation = Operation.CREATE, filters = {
      @Filter(property = “fulfilment.uid.partition”, value = “TW”)}, primary =
@SqlColumn(property = “fulfilment.uid”, column = “id”), version = @SqlColumn(property
= “fulfilment.version”, column = “version”), columns = {
      @SqlColumn(property = “orderID”, column = “orderId”)})}, dynamoTables = {
    @DynamoTable(name = “app-Fulfilment_demo”, operation = Operation.CREATE,
partitionKey = @DynamoPartitionKey(properties = {
      @DynamoProp(property = “fulfilment.uid”)
    }, name = “aggregateUID”), attributes = {
      @DynamoAttribute(property = “orderID”, name = “orderID”),
      @DynamoAttribute(property = “fulfilment.version”, name = “version”)}),
    @DynamoTable(name = “app-Fulfilment_HK_demo”, operation = Operation.CREATE,
filters = @Filter(property = “fulfilment.uid.partition”, value = “HK”), partitionKey =
@DynamoPartitionKey(properties = {
      @DynamoProp(property = “fulfilment.uid”)
    }, name = “aggregateUID”), attributes = {
      @DynamoAttribute(property = “orderID”, name = “orderID”),
      @DynamoAttribute(property = “fulfilment.version”, name = “version”)}),
    @DynamoTable(name = “app-Fulfilment_TW_demo”, operation = Operation.CREATE,
filters = @Filter(property = “fulfilment.uid.partition”, value = “TW”), partitionKey =
@DynamoPartitionKey(properties = {
      @DynamoProp(property = “fulfilment.uid”)
    }, name = “aggregateUID”), attributes = {
      @DynamoAttribute(property = “orderID”, name = “orderID”),
      @DynamoAttribute(property = “fulfilment.version”, name = “version”)})
})
public record FulfilmentCreated(AggregateMeta fulfilment, UUID orderID) implements
Type {
  @EventHandler
  public static Flux<IEventPayload> handle(IEventPayload e, FulfilmentCreated evt) {
    return Flux.just(e);
  }
}
```

The command gateway 804 may perform a lookup operation and create a command handler for a partition specific aggregate class or default (step 2). The command gateway 804 may perform a send operation and a register operation related to the event payload. The command gateway 804 may send commands related to the event payload to the command handler 806. The command gateway 804 may also send data for registration (i.e., saving) at the event store 805 via the interface of the event store 805.

Commands may be a data type to describe an intent to change the application's state. Some events may also be commands, wherein one microservice can directly send commands to other microservices. Note that events naming convention may use a past tense, representing some event happened to another service, while command naming may be present tense, representing action required to the current microservice

The event store 805 may perform register (i.e., save) operation for event sources and perform load operations of aggregate unique ID. That is, the event store 805 may save event sources to suitable partitions depend on the event store configuration and event unique ID partition.

The command handler 806 may process commands by a partitioned command handler, returning a list of event sources with its own event unique ID partitions (step 3). That is, the command handler 806 may perform aggregate processes related to the event payload and event sources.

The command handler 806 may also receive aggregate 808 user defined classes. The aggregate may include an event payload handle on event source. In an example, the aggregate 808 may obtain event data from a geographic region, e.g., from Hong Kong as denoted by aggregate HK 807. The aggregate 808 may partition specific aggregate classes from aggregate HK 807 that extends the global class. The aggregate HK 807 may include an event payload handle on event source from that geographic region. An example code regarding the aggregate 808 is shown below.

```
@Aggregate
public class Account {
  @AggregateID
  private AggregateUID id;
  @AggregateVersion
  private long version;
  @CommandHandler
  public Flux<IEventPayload> handle(OpenAccount command) {
    // User adds Business Logic
    return Flux.just(new AccountCreated(command.id( )));
  }
}
```

In highly regulated industries, e.g., financial industries, data governance auditing and requirement fulfilments are commonplace practices. The coverage may presently be manual and thus, requires significant resources to both audit and follow-up and for business, information technology, and engineering teams to constantly and continuously be vigilant to perform such data governance and management to ensure compliance. As such, a benefit of the event framework is to provide a framework architecture to consistently and constantly perform such data governance and management. The event source annotated classes may be well-defined persisted data models as part of an aggregate 808. These data class fields may be annotated with data classification and retention codes. Such codes may be detected by corresponding handlers to: (1) update data catalog inventory automatically (e.g., excess or obsolete inventory catalog data), (2) periodically ensure retention, destruction policy, adherence and (3) anonymize or mask highly confidential data to be published to less secure zones (such as production data into user acceptance testing (UAT) for reconciliation or testing purposes as part of development operations (DevOps).

Continuing with FIG. 8, through common event data format standardization, and user defined aggregate class creation, command gateway 804 intelligently knows the partition logic to load and process. Subsequently, event store 805 may independently save partitioned data in pre-configured backing storage mechanisms. Similarly, projection gateway 803 may define filters through event unique ID partitions (see example code shown below).

```
@Event
@Projection(sqlTables = {
  @SqlTable(name = “account_HK”, operation = Operation.CREATE_OR_UPDATE,
    filter = @Filter(property = “aggregate.uid.partition”, value = “HK”),
    primary = @SqlColumn(property = “data.sid”, column = “CLIENT_SID”),
    columns = {
      @SqlColumn(property = “data.id”, column = “CLIENT_ID”),
      @SqlColumn(property = “data.birthday”, column = “BIRTHDAY”),
      @SqlColumn(property = “data.status.value”, column = “STATUS”),
    })
})
public record OpenAccount(@AggregateID AggregateUID id, AccountDTO data) {
}
```

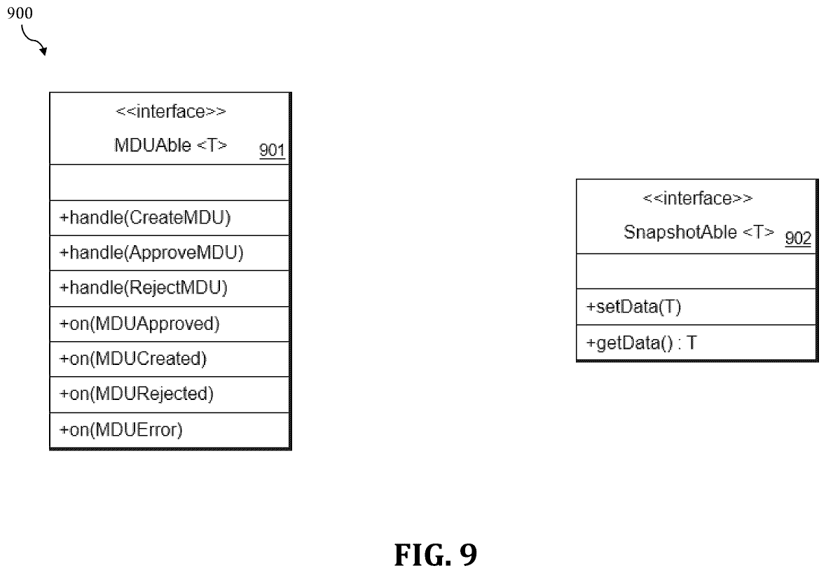

FIG. 9 illustrates example interfaces 900 of generating an event driven application for performing governed data processing, compilation, and analytics operations via an event framework according to an embodiment as described in FIG. 4. The event framework may be leveraged to create user-defined aggregate classes for processing, i.e., the event framework may be leveraged to provide secure manual data updates (MDU) with maker and checker pattern for general purpose processing. For instance, the creation of an abstract interface extension with pre-determined logic to handle plain data classes <T> and standardized event and event source handlers allows command gateway and publishing gateway to detect the use of the interface, which may allow users to continue to provide user defined classes, while enjoying out-of-the-box ability to create atomically safe maker-checker overrides of specific aggregate records with auditing. A MDUAble 901 interface of the event framework may perform these MDU operations.

Additionally, the event framework may include a snapshot interface to enable efficient data storage and transfer for systems that do not require complete history of all changes in the past. To allow framework users to optionally enable periodic snapshot of the latest state of aggregated data, aggregate of user defined classes may be utilized by implementing a standardized interface and abstract class as performed by a SnapshotAble 902 interface. Internal command handlers may detect and ensure that snapshots taken are transparent and effective, wherein the snapshots may be taken by the SnapshotAble 902. Additionally, event replays features may enable historical records to be populated to new or existing systems for testing, experimentation, migration purposes. Event store may replay specific aggregate records to target systems.

Furthermore, the event framework may provide a benefit of facilitating a granular level of access controls and auditing. For instance, the common event messaging format in the event framework may be designed to contain web tokens, which may encompass a user's data, as well as scope of system authorization in a single verifiable token. This enables event processing authentication and authorization checks wherein the event framework detects the presence of a web token, and automatically decodes and makes available the identity and authority to handlers. Additionally, annotations on commands may be used to ensure program callers in the event framework meet basic authorization scope checks and the ability to audit security events.

Another benefit of the event framework may be in providing general data exchange through event messaging. The event frameworks' processing may be defined by annotations or configurations. As such, an extension to the Event framework may allow a platform to enable users to define events and data and configure information exchange patterns in real-time as so desired, wherein these configurations may then be fed into the event framework for processing. That is, a benefit of the event framework may be in its operability as a low code platform, whereby specific event process logic may be specified in the low code platform by enabling software code interpreters to be executed that may be updated in real-time as a configuration. The low code platform (i.e., the event framework) may configure a general process platform without needing engineers or users to manage any infrastructure, while maintain high availability and resiliency with zero effort.

The event framework may also provide benefits such as, but not limited to: business process independence through infrastructure driver abstraction; business process data format standardization with automatic lineage tracking through distributed applications; data projection to create analytical data of business process result; replay of data to repopulate into new infrastructure platforms that ensures future aggregation of data for storing in various particular partitions; and centralized population of data intents (e.g., categorization and/or retention of data) into central data catalogues and managed instruction.

Although the invention has been described with reference to several embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that may be capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting embodiment, the computer-readable medium may include a solid-state memory such as a memory card or other package that houses one or more non-volatile read-only memories. Further, the computer-readable medium may be a random-access memory or other volatile re-writable memory. Additionally, the computer-readable medium may include a magneto-optical or optical medium, such as a disk or tapes or other storage device to capture carrier wave signals such as a signal communicated over a transmission medium. Accordingly, the disclosure may be considered to include any computer-readable medium or other equivalents and successor media, in which data or instructions may be stored.

Although the present application describes specific embodiments which may be implemented as computer programs or code segments in computer-readable media, it may be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

Although the present specification describes various numeric values, it is noted that these values are example values and are not intended to limit or restrict the present application to those values. Accordingly, replacement values having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for performing data processing and compilation operations, the method being implemented by at least one processor, the method comprising:
compiling an application built by an event framework with at least one infrastructure driver having an interface, wherein the at least one infrastructure driver comprises at least one from among a subscriber interface, an event gateway, an event handler, a command gateway, a command handler, an event store, a publishing gateway, a publisher, a projection gateway, and a projector;
implementing the event framework on a microservice architectural platform by connecting the at least one infrastructure driver with another one of the at least one infrastructure driver; and
performing the data processing and compilation operations by executing the event framework.

2. The method of claim 1, wherein the perform the data processing and compilation operations by executing the event framework comprises:
performing a simultaneous check of a data from the subscriber interface by the event gateway to determine whether the data is registered for the data processing and whether the event handler is registered to pre-process an event from the data;
upon determining that the event handler is registered to pre-process the event, performing a call operation to call the event handler;
performing the pre-processing of the event by the called event handler to generate a resulting data; and
transmitting the resulting data to the command gateway and the projection gateway.

3. The method of claim 2, further comprising:
transmitting the resulting data from the projection gateway to the projector, wherein the projector compares the resulting data with a compiled list of events and annotation codes to partition the resulting data for saving; and
executing conditional checks by the projector comprising at least one from among customized checks or checks based on predetermined annotated codes.

4. The method of claim 3, further comprising:
executing the command handler by the command gateway to process the event to generate the compiled list of events;
transmitting the compiled list of events to the publishing gateway;
saving the compiled list of events to the event store by the publishing gateway and to an outbox message for publishing by the publisher; and
triggering the publisher to load and publish the outbox message.

5. The method of claim 2, wherein the data comprises at least one from among structured data, raw data, and freeform data.

6. The method of claim 1, further comprising:
performing a command query responsibility segregation (CQRS) pattern adoption operation by automatically segregating command data processing in the command gateway with data projection via the projection gateway; and
implementing a processing pattern architecture to the event framework comprising at least one idempotent event type classification, a singular non-idempotent event type classification, and an at most one non-idempotent event type classification.

7. A computing apparatus for performing data processing and compilation operations, comprising:
a processor;
a memory;
a display; and
a communication interface coupled to each of the processor, the memory, and the display, wherein the processor is configured to:
compiling an application built by an event framework with at least one infrastructure driver having an interface, wherein the at least one infrastructure driver comprises at least one from among a subscriber interface, an event gateway, an event handler, a command gateway, a command handler, an event store, a publishing gateway, a publisher, a projection gateway, and a projector;
implementing the event framework on a microservice architectural platform by connecting the at least one infrastructure driver with another one of the at least one infrastructure driver; and
perform the data processing and compilation operations by executing the event framework.

8. The computing apparatus of claim 7, wherein the processor is configured to perform the data processing and compilation operations that executes the event framework by:
performing a simultaneous check of a data from the subscriber interface by the event gateway to determine whether the data is registered for the data processing and whether the event handler is registered to pre-process an event from the data;
upon determining that the event handler is registered to pre-process the event, performing a call operation to call the event handler;
performing the pre-processing of the event by the called event handler to generate a resulting data; and
transmitting the resulting data to the command gateway and the projection gateway.

9. The computing apparatus of claim 8, wherein the processor is further configured to:
transmit the resulting data from the projection gateway to the projector, wherein the projector compares the resulting data with a compiled list of events and annotation codes to partition the resulting data for saving; and
execute conditional checks by the projector comprising at least one from among customized checks or checks based on predetermined annotated codes.

10. The computing apparatus of claim 9, wherein the processor is further configured to:
execute the command handler by the command gateway to process the event to generate the compiled list of events;
transmit the compiled list of events to the publishing gateway;
save the compiled list of events to the event store by the publishing gateway and to an outbox message for publishing by the publisher; and
trigger the publisher to load and publish the outbox message

11. The computing apparatus of claim 8, wherein the data comprises at least one from among structured data, raw data, and freeform data.

12. The computing apparatus of claim 7, wherein the processor is further configured to:
perform a command query responsibility segregation (CQRS) pattern adoption operation by automatically segregating command data processing in the command gateway with data projection via the projection gateway; and
implement a processing pattern architecture to the event framework comprising at least one idempotent event type classification, a singular non-idempotent event type classification, and an at most one non-idempotent event type classification.

13. A non-transitory computer readable storage medium storing instructions for performing data processing and compilation operations, the non-transitory computer readable storage medium comprising executable code which, when executed by a processor, causes the processor to:
compile an application built by an event framework with at least one infrastructure driver having an interface, wherein the at least one infrastructure driver comprises at least one from among a subscriber interface, an event gateway, an event handler, a command gateway, a command handler, an event store, a publishing gateway, a publisher, a projection gateway, and a projector;
implement the event framework on a microservice architectural platform by connecting the at least one infrastructure driver with another one of the at least one infrastructure driver; and
perform the data processing and compilation operations by executing the event framework.

14. The non-transitory computer readable storage medium of claim 13, wherein the executable code causes the processor to perform the data processing and compilation operations that executes the event framework by:
performing a simultaneous check of a data from the subscriber interface by the event gateway to determine whether the data is registered for the data processing and whether the event handler is registered to pre-process an event from the data;
upon determining that the event handler is registered to pre-process the event, performing a call operation to call the event handler;
performing the pre-processing of the event by the called event handler to generate a resulting data; and
transmitting the resulting data to the command gateway and the projection gateway.

15. The non-transitory computer readable storage medium of claim 14, wherein the executable code causes the processor is further configured to:
transmit the resulting data from the projection gateway to the projector, wherein the projector compares the resulting data with a compiled list of events and annotation codes to partition the resulting data for saving; and
execute conditional checks by the projector comprising at least one from among customized checks or checks based on predetermined annotated codes.

16. The non-transitory computer readable storage medium of claim 15, wherein the executable code causes the processor is further configured to:
execute the command handler by the command gateway to process the event to generate the compiled list of events; and
transmit the compiled list of events to the publishing gateway.

17. The non-transitory computer readable storage medium of claim 16, wherein the executable code causes the processor is further configured to:
save the compiled list of events to the event store by the publishing gateway and to an outbox message for publishing by the publisher; and
trigger the publisher to load and publish the outbox message.

18. The non-transitory computer readable storage medium of claim 14, wherein the data comprises at least one from among structured data, raw data, and freeform data.

19. The non-transitory computer readable storage medium of claim 13, wherein the executable code causes the processor is further configured to perform a command query responsibility segregation (CQRS) pattern adoption operation by automatically segregating command data processing in the command gateway with data projection via the projection gateway.

20. The non-transitory computer readable storage medium of claim 19, wherein the executable code causes the processor is further configured to implement a processing pattern architecture to the event framework comprising at least one idempotent event type classification, a singular non-idempotent event type classification, and an at most one non-idempotent event type classification.
